(19) United States
(12) Patent Application Publication
(10) Pub. No.: US 2004/0157082 A1
(43) Pub. Date: Aug. 12, 2004

(54) Coated magnetically responsive particles, and embolic materials using coated magnetically responsive particles

(76) Inventors: Rogers C. Ritter, Charlottesville, VA (US); Jonathan Harburn, England (GB); Christopher Spilling, St. Louis, MO (US); Kathleen M. Miller, St. Louis, MO (US)

Correspondence Address: HARNESS, DICKEY, & PIERCE, P.L.C, 7700 BONHOMME, STE 400, ST. LOUIS, MO, 63105, US

(21) Appl. No.: 10/623,863

(22) Filed: Jul. 21, 2003

Related U.S. Application Data
(60) Provisional application No. 60/397,996, filed on Jul. 22, 2002.

(51) Int. Cl. H01F 1/00

(52) U.S. Cl. 428/611; 335/209

(57) ABSTRACT

An embolic material comprising a polymerizable hydrophobic suspension of coated magnetically responsive particles (e.g. magnetite Fe₃O₄) suspended in a solvent monomer, a bulking agent, a radiopaque monomer, and an accelerant, and an initiator. The coated magnetically responsive particles preferably have a diameter of between about 20 and about 40 nm, and a magnetically responsive core with a diameter of between about 2 and about 20 nm.

### CROSS REFERENCE TO RELATED APPLICATION

This application claims priority of prior provisional U.S. Patent Application Serial No. 60/397,996, filed Jul. 22, 2002, the entire disclosure of which is incorporated herein by reference.

### FIELD OF THE INVENTION

This invention relates to magnetically responsive particles for use in embolic materials, and to embolic materials incorporating magnetically responsive particles.

### BACKGROUND OF THE INVENTION

Embolic materials are flowable, settable materials intended to be delivered to the site of a defect, such as an aneurysm, in a subject's vasculature, to occlude the defect. A number of attempts have been made to develop a safe and effective embolic material, but it has proven difficult to accurately deliver embolic materials to the site of the vascular defect and to control the embolic material at the site of the vascular defect. Failure to control the embolic material can permit some of the material to escape and possibly block healthy blood vessels, potentially even causing strokes.

Significant progress has been made in the magnetic delivery and control of embolic materials, for example as disclosed in U.S. Pat. No. 6,375,606, entitled Methods Of And Apparatus For Treating Vascular Defects; U.S. Pat. No. 6,364,823, entitled Methods Of And Compositions For Treating Vascular Defects; U.S. Pat. No. 6,315,709, entitled Magnetic Vascular Defect Treatment System; and U.S. Pat. No. 6,296,604, Methods Of And Compositions For Treating Vascular Defects, the disclosures of each of which are incorporated herein by reference. Despite the improvements of the embolic materials and delivery methods set forth in these patents and application, continued improvements in embolic materials are still very desirable.

The addition of magnetically responsive particles is a good way to make an embolic material magnetically responsive. However, magnetically responsive particles tend to agglomerate, sometimes permanently, upon the application of a magnetic field. To maintain desirable properties for the embolic, it is desirable that the particles not agglomerate in this manner. However it is desirable that the particles exhibit some degree of attraction, so that the embolic material remains cohesive, and so that portions of the material do not slough off before the embolic sets.

### SUMMARY OF THE INVENTION

Generally, the embolic material of the present invention comprises a polymerizable hydrophobic suspension of coated magnetically responsive particles (e.g. magnetite Fe₃O₄) suspended in a solvent monomer, a bulking agent, a radiopaque material, and an accelerant, and an initiator. The coated magnetically responsive particles are sufficiently large and in sufficient quantity to make the embolic material responsive to an applied gradient of at least 1 T/m and more preferably at least 0.5 T/m and in an aligning field of 0.1T. The coating is sufficiently thick to reduce agglomeration of the magnetically responsive cores and provides at least some interparticle cohesion.

In the preferred embodiment, the particles comprise a core with a diameter between about 2 nm and about 20 nm, and more preferably between about 7 and about 15 nm. The coating gives the particles a total diameter of between about 20 and about 40 nm, and more preferably between about 25 nm and about 35 nm.

### BRIEF DESCRIPTION OF THE DRAWINGS

FIG. 1 is an illustration of the magnetic forces that occur between a few magnetite particles that are aligned by an externally applied axial magnetic field;

FIG. 2A is a plot of the force between a pair of magnetite particles having a buffer coating of 10% of the particle radius, as a function of their radius;

FIG. 2B is a graph of the number of 1 eV bonds per particle pair required to equal the repulsive force between the particles for 10 nm particles with a thick coating;

FIG. 3 is a graph showing the desired potential energy behavior that would provide such a combination of forces between particles for stabilization under magnetic field to prevent agglomeration;

FIG. 4 is a schematic diagram of a magnetically responsive particle in accordance with the principles of this invention;

FIG. 5 is a schematic diagram of the synthesis of a polymer backbone with reactive chains to form a coating material for magnetically responsive particles;

FIG. 6A is an illustration of one radiopaque monomer that can be incorporated into the embolic materials of this invention to increase radiopacity of the embolic material;

FIG. 6B is an illustration of another radiopaque monomer that can be incorporated into the embolic materials of this invention to increase radiopacity of the embolic material;

FIG. 7A is an illustration of the reaction of poly(propylene glycol) monobutyl ether with (p-nitrophenyl)chloroformate to give the unsymmetrical carbonate;

FIG. 7B is an illustration of the displacement of the nitrophenyl group with ethylenediamine to give the PPG-aminocarbamate ready for coupling to the backbone poly(carboxylate).

FIG. 8A is an illustration of the reaction between norbornene anhydride with PPG amino carbamate (FIG. 7B) to form a monoacid

FIG. 8B is an illustration of the ring opening metathesis polymerization (ROMP) process useful for forming coatings for magnetically responsive coated particles in accordance with the present invention;

FIG. 9 is an illustration of another process useful for forming coatings for magnetically responsive coated particles in accordance with the present invention;

FIG. 10A illustrates a process for preparing a radiopaque monomer for ROMP polymerization, the polymerization of radiopaque monomers in accordance with this invention; and

FIG. 10B illustrates a ROMP polymerization process incorporating radiopaque monomers of FIG. 10A.

FIG. 11 is a photograph of a glass lateral aneurysm model fill with embolic containing radiopaque iodine monomer, with gravity (A) and against gravity (B);

FIG. 12 is a size distribution of the magnetite core of the polyacid coated magnetite particles, from TEM data;

FIG. 13 is a size distribution of the gold core of coated gold particles, from TEM data;

FIG. 14 is an illustration of the reaction of the PPG aminocarbamate with mercapto acetic acid to give thiol-terminated long chain polymer coating.

### DETAILED DESCRIPTION OF THE INVENTION

In general, design of an embolic material and method must be done with great care to prevent internal instability leading to downstream migration of some of the material. The essence of the difficulty is in managing the need for safe magnetic pulling of the bulk material into the aneurysm, but which is opposed by inter-particle repulsive magnetic forces that develop within the embolic. The present invention is an embolic embodiment that provides a more complete solution to this difficult behavior. In essence, application of the new discovery of the relation of magnetic particle behavior and chemical bonding and interactions of appropriate types is able to prevent the disruptive agglomeration that is characteristic of magnetic fluids in strong magnetic fields.

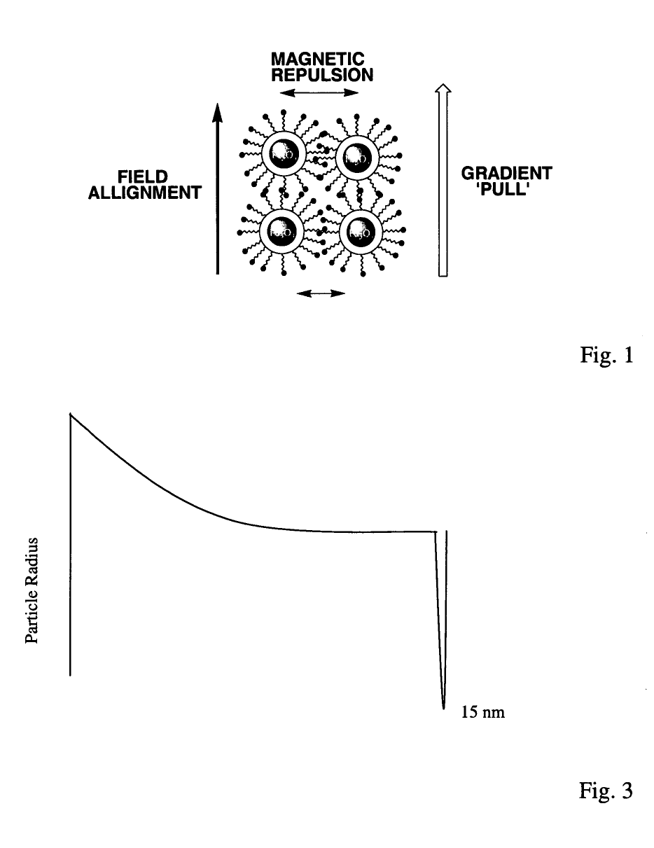

FIG. 1 illustrates the magnetic forces that occur between a few magnetite particles that are aligned by an externally applied magnetic field. As shown in FIG. 1 the magnetic field and magnetic gradient are parallel, but the field and gradient could be oriented at an angle with respect to each other, and could even be perpendicular. The particles in relative positions with dipoles aligned end-to-end are attracted to each other, while those that are side-by-side repel each other. In larger regions the array is not so perfectly arranged as shown, and the particles tend to clump, or agglomerate. These clumps form in roughly striated regions that strongly repel other striated regions, causing the instability and easily induced separation of segments of the embolic.

It can be difficult to make small magnetite particles with appropriate coatings for buffering and for the chemical bonding of radiopaque materials, or other chemical moieties, as desired. Roughly spherical particles of about 10 nanometer diameter, however, can be made with reasonable effort. It has been expected and found from laboratory experiments, that these approximately 10 nanometer magnetite particles with appropriate coatings form the most stable magnetic fluids. It has also been found that for various reasons, the optimal amounts of magnetite particles in the formulation of an embolic is in the range about 0.01 to about 0.05 of the volume (i.e. about 1 to about 5 percent). Larger amounts increase the tendency towards agglomeration, and also will render the embolic fills less safe for future MRI imaging of the patient. Lesser amounts result in embolic materials that are too weakly magnetic, and consequently would require large magnetic gradients, and thus large magnets to generate these gradients.

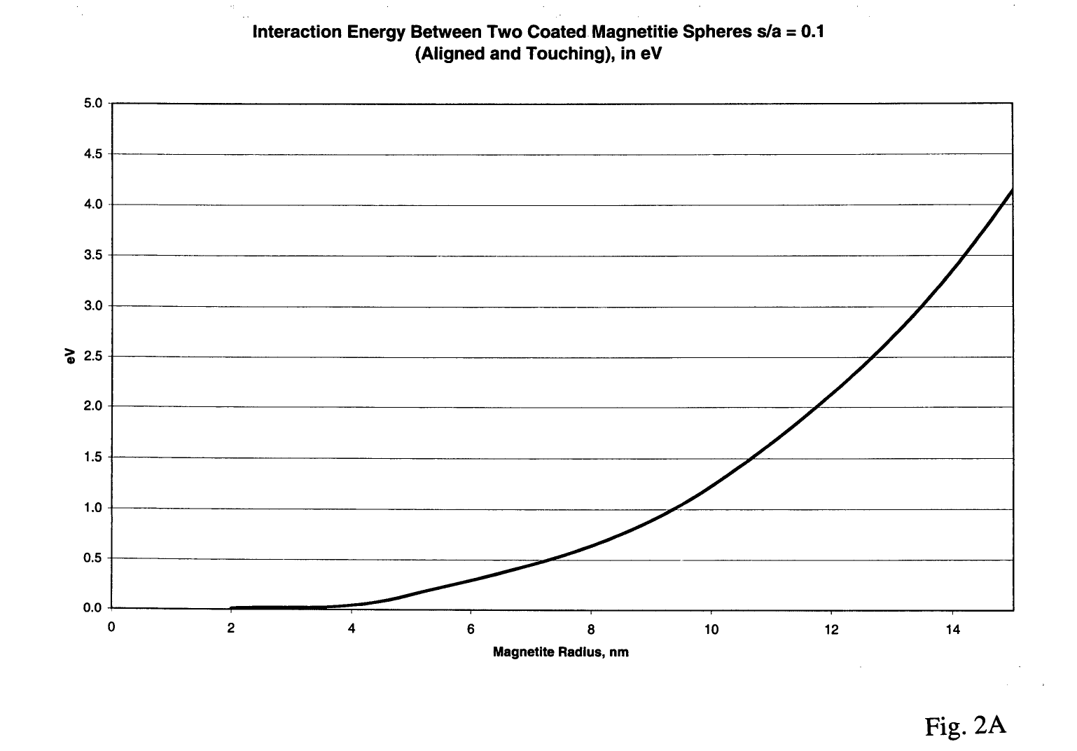

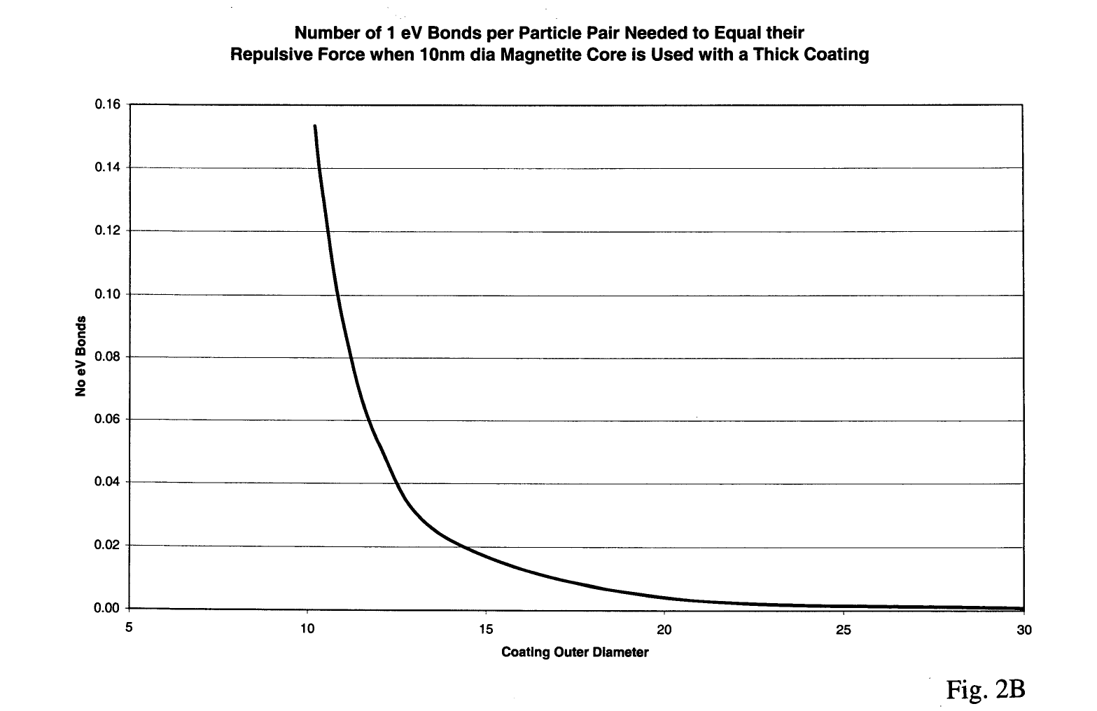

FIG. 2A is a plot of the force between a pair of magnetite particles having a buffer coating of 10% of the particle radius, as a function of the radius. It is seen that for a radius of 5 nanometers, the interparticle force is a small fraction of an electron-volt (eV). Therefore, if applied appropriately, ordinary ˜1 eV chemical bonds (23 kcal/mol) could easily prevent the separation of pairs of repulsive magnetite particles.

However, chemical bonds have relatively short ranges—on the order of about 0.1 to about 0.2 nanometers. But the average separation of the centers of coated magnetite particles of the above stated concentrations is on the order of 30 nanometers. The edge-to-edge spacing between nanoparticles is approximately 20 nanometers, i.e. several hundred times the length of a typical chemical bond. What is desirable, then, is to find a way to keep the particles at a relatively uniform 20 nanometers apart, while also holding them together just beyond that separation. FIG. 3 shows the nature of a potential energy behavior that would provide such a combination of forces. Such a potential is not readily available in typical chemical bonds. This invention provides ways to provide this potential well.

Another aspect of this invention is the provision of a coating which provides an interfacial tension against separation, and acts as an overall “coating” to assist the magnetic attraction in holding the embolic as a unit. This coating can preferably be hydrophobic, and therefore cause an interfacial tension in the presence of an aqueous system such as blood. This must be capable of acting during the filling period, but may have features such as scissile bonds which can allow it to appropriately attach to the hydrophilic tissue of the aneurysm wall. It can also be appreciated that this coating thickness significantly controls the volume percentage of magnetite in an embolic.

The inventors have found ways to use, and to quantitate (within reasonable error) the relationship between magnetic core particle size, coating size, particle number density in an embolic magnetic fluid, and the needed chemical bonding in order to prevent any material separation during aneurysm filling. An unusual aspect of energy interactions must be dealt with chemically for this to be functional. FIG. 3 shows an effective overall potential energy diagram illustrating the sharp well at the surface of a coated magnetite particle which would satisfy this requirement. While the coating would need to be some nanometers thick, chemical bonds operate over distances much shorter than that, roughly 0.1 nm. This is an aspect of magnetic fluid stability which is new in this invention, and which adds a component to the fluid design. See, e.g. the book Magnetoviscous Effects in Ferrofluids, Stefan Odenbach, Springer, pp 7 to 20 for a clear expression of the standard treatment and meaning of “stability” in a magnetic fluid. In these treatments, stability is maintained against gravity by having particles of a small size so that the thermal agitation energy is comparable to the gravitational energy on a particle, thus affording colloidal stability. In addition, stability is maintained against magnetic fields by sizing and buffering the particles so that the inter-particle magnetic energy is kept below an amount that would lead to serious agglomeration. The limiting factor of this method alone is that the tremendously rapid increase of magnetic inter-particle energy with particle diameter leads either to the need for ridiculously thick coatings, or for a very sparse number density of the particles, even when they are small, e.g. 10 nm diameter, so that the material is magnetically weak. In essence, steric repulsion has been the only means of overcoming the tendency of a more dense aggregate of coated particles from agglomerating, leading to striation and material separation in a filling aneurysm.

In the present invention, the chemical requirements are brought into play so that a combination of repulsion and attraction of the “legs” which constitute also the steric buffering, will maintain adequate particle separation, and yet hold them together. FIGS. 2A and 2B show the energetics of the situation. In essence, the legs must be somewhat stiff to maintain moderate separation, and yet their interparticle entanglement can provide the effective attraction to prevent material separation in a filling aneurysm. Thus, tensile chemical bonds on the outer covering of a ball are not necessary to accomplish the function inferred in FIG. 3. These entanglements need not individually be very strong to be effective. For example FIG. 2B shows that two parallel-aligned 10 nm diameter magnetite cores coated to overall diameters of about 24 nm each would require only about 1/16 of a one-eV chemical bond to overcome the repulsion between them.

Consequently, when a magnetic fluid is made of such particles and coatings, the stability against agglomeration which would lead to material separation is maintained by properly designed chemical coatings, unlike the stability of previous art which, applied to contained mechanical situations, did not require such rigorous protection against any material separation, and therefore did not use this characteristic. In addition, this aspect of the embolic will assist an interfacial tension acting at the embolic surface in avoiding any non-magnetic material separation before polymerization.

A first embodiment of this invention is the use of relatively thick (approximately 10 nm) coating on the magnetically responsive (e.g. magnetite) particles. FIG. 1 shows one way in which such a particle can be designed. A thick polymer coating contains long chains which create a physical barrier to prevent the close approach of the central particles and lessens the interparticle force of a pair of repulsive magnetite particles. The polymer coatings can also incorporate radiopaque moieties for visualizing under x-ray. The chains can entangle and interact with each other and also interact with other chemical moieties in the embolic material through multiple intermolecular forces, such as dipole-dipole interactions or van der Waal's forces, to prevent separation and maintain stability of the particle suspension (recalling that only weak bonding is needed at that separation).

Another embodiment of this invention uses appropriate gels (which contain long protein strings) as the separation and entanglement agent. Thermogels whose viscosity increases with temperature would be particularly suitable, and more particularly thermogels whose viscosity increases in the range of normal body temperature 37° C. See, Y. Matsumaru et al., Application of Thermosensitive Polymers as a New Embolic Material for Intravascular Neurosurgery, 7 J. Biomaterial. Sci. Polymer Edn. 795-804 (1996).

Some of the embodiments of this invention will have the need for separate bonds for other functions such as attachment of radiopaque materials and polymerizable material for solidifying the injected embolic. In some embodiments, the radiopaque materials and polymerizable material will be provided by separate components of the embolic formulation.

MRI safety implies that magnetic forces exerted on a filled aneurysm in a patient will not be so strong as to cause any rupture to the aneurysm wall. The force on a filled embolic will be proportional to the MRI field gradient, which can only be significant at the patient entrance into the bore. Therefore, a feature of this invention is that smaller volume fractions of magnetite particles can be usefully employed, thereby reducing the force exerted on the embolic as a patient passes through a magnetic gradient upon entering the MRI device.

In addition to MRI safety, MRI compatibility is of interest. This compatibility involves the ability to make useful MR images in the vicinity of the filled aneurysm. Typically, MRI images near elements having significant electrical conductivity are distorted. Appropriate coatings on magnetite will be non-conducting. Therefore, an aneurysm filled with the thick coated magnetite will have only the tiniest, 10 nanometer conducting regions.

According to one aspect of this invention, an embolic is provided that consists of a polymerizable hydrophobic suspension of coated magnetically responsive particles (e.g. magnetite Fe₃O₄) suspended in a polymerizable solvent containing a bulking agent, a radiopaque monomer, and an accelerant, which prior to use is mixed with a second solution comprising a monomer and an initiator. According to another aspect of the invention, an embolic is provided that consists of a polymerizable hydrophobic suspension of coated magnetically responsive particles (e.g., magnetite Fe₃O₄) suspended in a polymerizable solvent containing a bulking agent, cross-linkers, coated radiopaque particles (e.g. coated gold), and an accelerant, which prior to use is mixed with a second solution comprising a monomer and initiator. The polymerization times can be altered by adjusting the accelerant and/or initiator concentrations.

The Coated Particles

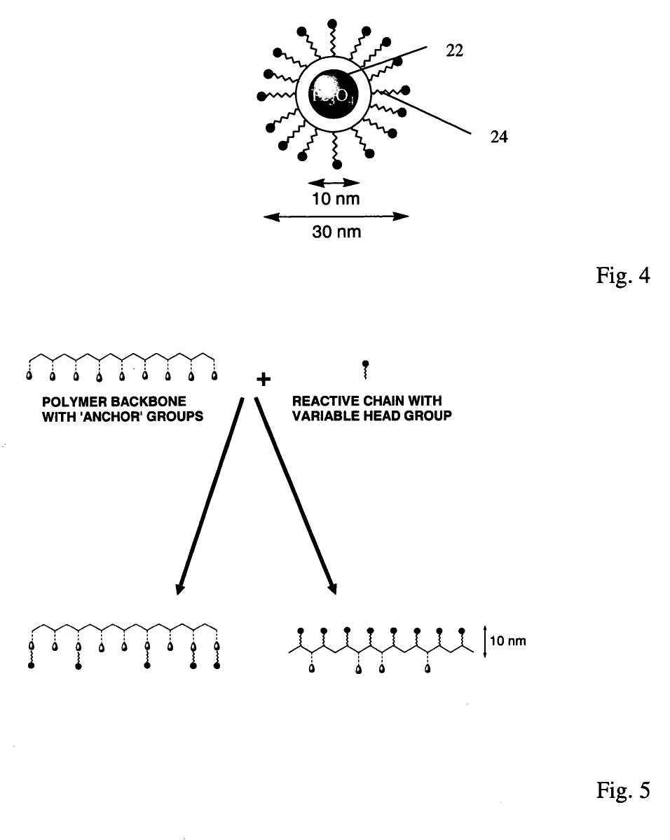

A single coated particle is shown schematically in FIG. 4. The particle consists of a core 22 and a coating 24. The core 22 is preferably made of a magnetically responsive material, such as magnetite (Fe₃O₄). The cores 22 could also be hematite (Fe₂O₃), cobalt, iron, mixtures or alloys thereof, or other magnetic particles which could be made biologically compatible, for example with coatings. The magnetic particles preferably comprise magnetic bodies, preferably made of a permeable magnetic material, such as the iron oxides magnetite (Fe₃O₄) or maghemite (Fe₂O₃), or ferrites of the general form MO—Fe₂O₃, where M stands for Fe, Ni, Mn, Co, or Mg. Most superparamagnetic, ferromagnetic, and ferrimagnetic metal alloys and garnets may also be used as magnetic bodies. Examples are Pt/Fe (ferromagnetic alloy) and R₃Fe₅O₁₂ (where R=atomic number 39, 62-71, ferromagnetic garnets). It would be desirable if the particles were radiopaque, so that the delivery of the particles could be monitored by x-ray or fluoroscope. Thus the particles could include, for example, barium in the form of a barium iron oxide, e.g., BaO.Fe₂O₃, gadolinium, or europium or other suitable radiopaque material. Of course all of the cores 22 do not have to have the same composition, and portions of the particles could have cores of different materials to provide particular properties to the embolic material.

Coated particles could be radiopaque and not magnetically responsive, to provide the embolic formulation with radiopacity for visualization under x-ray. The radiopaque particles would be nanoparticles of materials that are highly x-ray absorbing, such as heavy metals with atomic numbers 53-83, but especially coated platinum, tantalum, or gold nanoparticles.

The magnetically responsive cores 22 are preferably generally spherical, but could be some other shape (e.g., oblong or needlelike), which could provide advantages in heating the embolic in an ac magnetic field to control cure. The maximum diameter (or dimension in the case of non-spherical particles) of the coated particles is preferably less than about 40 nm, and more preferably less than about 35 nm and most preferably less than about 30 nm. The minimum diameter (or dimension) of the magnetically responsive cores 22 is preferably greater than about 2 nm, more preferably greater than about 5 nm, and most preferably greater than about 7 nm. The smaller the diameter of the magnetically responsive core, the less responsive the particle is to an applied magnetic field or gradient. The larger the diameter of the magnetically responsive core, the greater the tendency of the particles to clump together, and the harder it is to overcome this tendency by applying a buffering coating to the particles. It is also the case that particles in this “subdomain” region no longer act as larger homogeneous ferromagnetic materials, and can develop in some cases different properties. For example, they can sometimes behave somewhat as small permanent magnets. Such particles are difficult to produce in highly uniform size, but variations of plus or minus 30% are usually acceptable. In general it is desirable for most applications to have an aspect ration of about 1.2 or less, and most preferably about 1.

The embolic material into which the particles are incorporated is subjected to strong externally applied magnetic gradients (typically on the order of 0.5 to 1 T/m) to pull the embolic into the vascular defect and hold it there against the hemodynamic forces caused by the blood flowing through the vasculature. The magnetic field that supplies the gradient must also provide the induced or rotational alignment of dipoles in order for such gradients to effectively attract them. Typical magnetic fields might be 0.05 to 0.1 T. In such a magnetic field and gradient, the ineffectively buffered cores would tend to agglomerate in long strings of mutually attracting particles, which are mutually repulsive as illustrated in FIG. 1. These strings form dendrites which can impair proper filling of a vascular defect, and they also promote sloughing of material before it cures, possibly causing embolization of healthy vasculature. The inventors have discovered that these tendencies can be reduced by appropriately coating the magnetically responsive cores to inhibit the formation of strings when a magnetic field is applied.

In one preferred embodiment the coating consists of a polyacid backbone, such as a poly(carboxylic acid) backbone, bonded to a side chain of varying molecular weight and composition via ester or amide bonds. The polyacid backbone provides multiple carboxylate chelators to bond the coating to the magnetite surface, which should result in a very stable coated particle. A schematic drawing of the polyacid backbone with attached side chains in shown in FIG. 5. The side chains can be terminated in differing head groups, such as a non-functional butyl ether, a reactive group such as an acrylate for polymerization, or a radiopaque group such as an iodinated moiety or a chelator system, such as Gd-DTPA, to provide radiopacity. Other possible terminating groups could be biological molecules, such as polypeptide receptors or gene vectors for drug delivery. Side chain selection is based on calculated HLB (hydrophile-lipophile balance) values and required coating thickness. The HLB value is preferably matched to the dispersing solvent of choice, which is used to swell and expand the polymer chains to their maximum extension and dispersion, which is also a property of δ solvents when properly matched to the properties of the polymer chains (as discussed in D. W. Van Krevelan, “Properties of Polymers”, Elsevier, 1997, 200-214, especially page 214, incorporated herein by reference). The side chain length provides a thick coating to buffer the particle magnetic interaction and to provide cohesive chemical interactions to maintain embolic stability

The side chains consist of polymers or copolymers. In one preferred embodiment, a poly(propylene glycol) monobutyl ether (PPG) side chain, for example poly(propylene glycol) monobutyl ether, Mₙ≈4,000, available from Aldrich Chemical Co., St. Louis, Mo., is used. A poly(propylene glycol) polymer with Mn≈4000 is desirable for the side chain since the HLB value calculated at 17.35 indicates that a stable suspension of PPG coated magnetite particles would form in methyl methacrylate, which has an HLB value of 21.65. PPG with Mn≈4000 contains approximately 67 repeat units and, if uncoiled, would have a length of approximately 16 nm, which would provide sufficient buffering for a 10 nm diameter magnetic particle. The uncoiled length is indicative of the maximum coating thickness around the cores. Using published procedures, such as those disclosed in V. G. Babak, R. Gref, E. Dellacherie “The Effect of Hydrophile-Lipophile Balance of Water-Soluble Poly(ethylene glycol)-Poly(lactic acid) diblock copolymers on the Stability of Microscopic Emulsion Films and Nanoemulsions”, Mendeleev Communications, 1998, 105-107; T. Fujita, T. Miyazaki, H. Nishiyama, B. Jeyadevan, “Preparation and Properties of Low Boiling Point of Alcohol and Acetone-Based Magnetic Fluid”, Journal of Magnetism and Magnetic Materials, 1999, 200, 14-17, (incorporated herein by reference), poly(propylene glycol) monobutyl ether is reacted with (p-nitrophenyl)chloroformate to give the unsymmetrical carbonate, as shown in FIG. 7A. The nitrophenyl group is displaced with ethylenediamine to give the n-butoxy—(PPG)-aminocarbamate ready for coupling to the backbone poly(carboxylate), as shown in FIG. 7B.

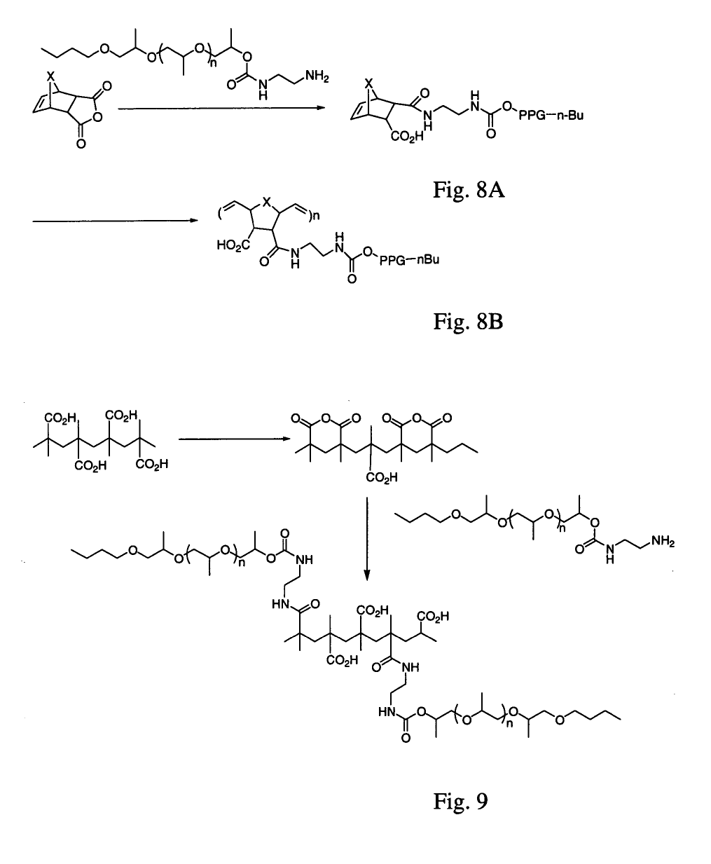

The preferred method of making the polyacid backbone coating is reacting norbornene anhydride with n-butoxy (PPG) amino carbamate (FIG. 7B) to form a monoacid, as shown in FIG. 8A, and then conduct ring opening metathesis polymerization (ROMP) using a second generation Grubbs catalyst, as shown in FIG. 8B, to yield a coating material. It can be appreciated that opening the poly(carboxylic anhydride) with different side chains in the ROMP polymerization reaction would yield a polyacid backbone with chains of different types. This method would allow, for example, the introduction of chains with radiopaque iodine moieties, as shown in FIGS. 10A and 10B. It also may be possible to create a biodegradable coating by linking poly(lactate) side chains to the polyacid backbone.

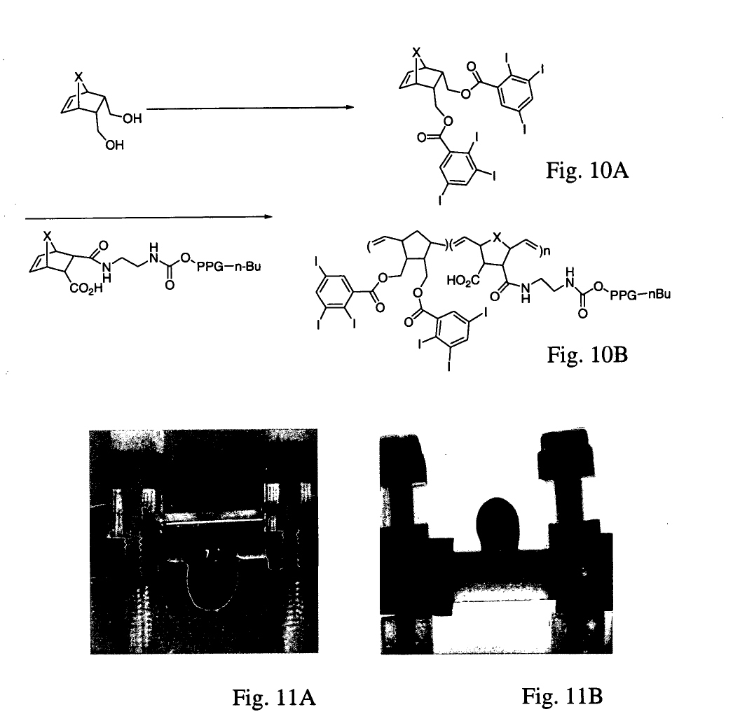

In another embodiment of the coating, the polyacid is poly(methacrylic acid), in which 13 residues coiled yields a total length of 40.477 Å. Assuming no expansion on derivitisation, the monomer unit is 3.987 Å and its molecular weight is 100.117 gm/mole. Given the 31 nm circumference of a 10 nm diameter magnetic particle, the number of monomer acid units for the poly(methacrylic acid) backbone to extend around the circumference of the magnetic particle can be calculated as 310/3.987=78 monomer units. The maximum molecular weight is then 78*100.117=7784 gm/mole. The molecular weight of the poly(methacrylic acid) in the coupling reaction with the poly(propylene glycol) side chains would be kept below this value to facilitate binding to the surface of the 10 nm magnetite particle. FIG. 9 shows the synthesis of a magnetic particle coating containing poly(methacrylic acid) with poly(propylene glycol) side chains.

To create a magnetic particle delivery system it is desirable to use a hydrophobic coating on the outside of a magnetic particle so as to retain the interfacial tension required to keep the particles together when pulled by a magnetic gradient in a biological aqueous system, such as in the blood stream.

To create a magnetic particle system in which the initial hydrophobically-coated magnetic particles may then be biodegraded/degraded into a hydrophilically-coated magnetic particles which may then be removed by, for example, renal excretion, a double layer ‘hair’ approach can be utilized. This allows the particles to initially display hydrophobic properties, and subsequently to cleave the coating to separate the magnetically responsive particle with hydrophilic functionality, e.g. to facilitate its removal by solvent extraction or to facilitate its bonding with the aneurysm walls. In this approach a long hydrophobic polymer (e.g. poly(propylene glycol)) may be coupled to a hydrophilic portion (e.g. poly(ethylene glycol)) through a scissile bond (e.g., amide/ester bond) which is then attached to the internal polymer backbone (e.g., poly acid). The large hydrophobic portion is then on the outside when attached to the magnetic core and as such ‘camouflages’ the particle and therefore may be dispersed in organic solvents/monomers/contrast. In organic solvents/monomers/contrast the hydrophobic portion swells while the hydrophilic portion contracts. On cleavage of the scissile bond (e.g., through hydrolysis/protease cleavage) the hydrophilic portion is then exposed to an aqueous environment, the coating swells to absorb water and the hydrophilically-coated magnetic particles may disperse in the blood and may be excreted downstream through glomular filtration, or which can be polymerized to a solid which adheres to the aneurysm wall.

The reverse principle may be utilized if needed to go from a hydrophilically-coated magnetic particles to a hydrophobically-coated magnetic particles. It is also possible to construct coatings that can change from hydrophobic to hydrophilic and back to hydrophobic, or from hydrophilic to hydrophobic back to hydrophilic.

In still another embodiment of the present invention, an aqueous suspension of coated magnetic particles can be made, for example using poly(ethylene glycol) of varying molecular weight. The backbone polymer and side chain coupling can be the same as for the hydrophobic embodiments described above.

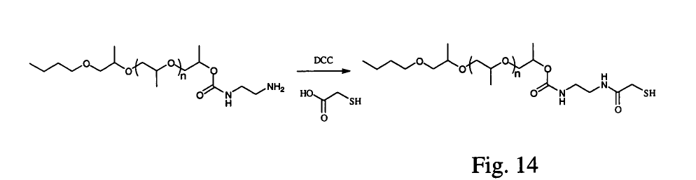

In still another embodiment, the coating is a long chain polymer coating terminated in a thiol group for optimal coating of radiopaque particles, such as gold nanoparticles. Thiol terminated polymer chains are known to bind to gold particles, as discussed in “Grafting of Alkanethiol-Terminated Poly(ethylene glycol) on Gold”, S. Tokumitsu, et al., Langmuir, 2002, 18, 8862-8870 (incorporated herein by reference). See FIG. 14.

Preparation of the Coated Magnetite Particles

### EXAMPLE 1

### Synthesis of Polyacid Backbone Coating for Magnetite Nanoparticles using ROMP Method

Step 1. Preparation of p-Nitro Carbonate Derivative of Poly(Propylene Glycol) Monobutyl Ether

Poly(propylene glycol) monobutyl ether Mₙ≈4000 (300 g, 0.075 mole) was dissolved in 100 ml of distilled CH₂Cl₂ and dry triethylamine (18 ml, 1.7 eq.) in a flame dried round bottomed flask. Para-nitrophenyl chloroformate (18.14 g, 0.0899 mole) was added in portions over 0.5 h with stirring, under argon. The mixture was stirred overnight (16 hrs) at room temperature. The solution was diluted with 100 ml CH₂Cl₂ and washed once with 100 ml Millipore water. The organic layer was collected and dried over MgSO₄, filtered, and the solvent removed in vacuo to give 168 g of a viscous, slightly yellow oil (54% yield). This reaction is illustrated in FIG. 7A.

Step 2. Preparation of the Carbamate Derivative of Poly(Propylene Glycol) Monobutyl Ether

Ethylene diamine (32.6 ml, 10 eq., 0.4887 mole) was dissolved in 100 ml distilled CH₂CL₂ in a flame dried round bottomed flask. Poly(propylene glycol) monobutyl ether Mₙ≈4000 para nitrophenyl carbonate (100 g, 0.075 mole) was dissolved in 50 ml of distilled CH₂Cl₂ and added in portions over 0.5 hr with stirring, under argon. The mixture was refluxed at 70° C. for three hours. Formation of a bright yellow precipitate was observed. The solid was filtered off and the filtrate was diluted with 100 ml CH₂CL₂ and washed twice with 100 ml portions of millipore water. The organic layer was collected and dried over MgSO₄, filtered, and the solvent removed in vacuo to give 54 g of a viscous, bright yellow oil (53% yield). This reaction is illustrated in FIG. 7B.

Step 3. Opening Norbornene Anhydride

Poly(propylene glycol) monobutyl ether Mₙ≈4000 carbamate (55.65 g, 0.0136 mole) was dissolved along with 8 ml of dry triethylamine in 100 ml of distilled CH₂CL₂ in a flame dried round bottomed flask. Norbornene dicarboxylic anhydride (2.17 g, 0.0135 mole, 0.99 eq.) was dissolved in 20 ml of distilled CH₂Cl₂ and added to the carbamate solution with stirring, under argon. The mixture was refluxed at 75° C. for two hours and then left to stir at room temperature overnight (16 hours). The reaction mixture was diluted with 100 ml chloroform and washed twice with 100 ml portions of 10% HCl solution. The organic layer was collected and dried over MgSO₄, filtered, and the solvent removed in vacuo to give 55.8 g of a viscous, light yellow oil (96% yield). This reaction is illustrated in FIG. 8A.

Step 4. Ring Opening Metathesis Polymerization to Yield Norbornene Derivative

The derivative of nobornene anhydride (24.24 g, 0.0058 mole) was dissolved in 100 ml of distilled, degassed CH₂Cl₂. This solution was further degassed (deoxygenated) for 0.5 hrs by bubbling argon through it. Grubb's second generation catalyst (140 mg; Aldrich Chemical Company, St. Louis, Mo.) was added while stirring under argon. The solution went from yellow to red immediately. The solution was refluxed for two hours under argon and allowed to stir overnight at room temperature. Ethyl vinyl ether was added and the resulting mixture was stirred at room temperature for a further 30 minutes. The reaction mixture was diluted with 100 ml chloroform and washed once with 100 ml of millipore water containing 8 drops of tris(hydroxymethyl) phosphine. The organic layer was collected and dried over MgSO₄ and filtered through a small column of neutral alumina. The solvent was removed in vacuo to give 15.18 g of a viscous, amber oil. This reaction product is illustrated in FIG. 8B.

### EXAMPLE 2

### Synthesis of Magnetite Particles Coated with the Polyacid Backbone Coating Prepared Using the ROMP Method

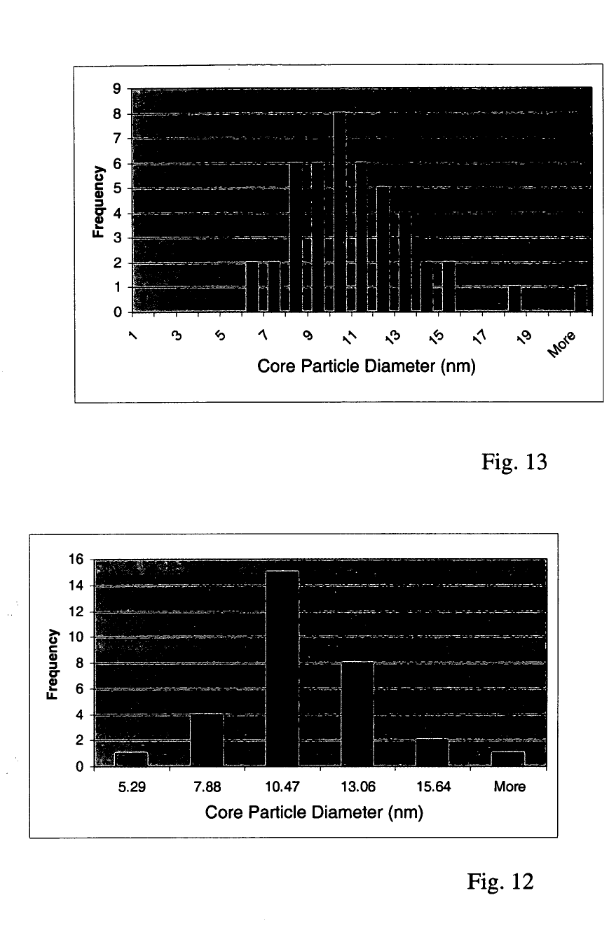

In three round bottom flasks were placed 40 ml of deionized H₂O, 25 ml of CH₂Cl₂ containing 5 g of the polyacid backbone polymer coating prepared as in Example 1, and 25 ml of 50% concentrated NH₄OH. These were deoxygenated with argon for 30 minutes. The salts, 2.5 g of FeCl₃.6H₂O and 0.92 g of FeCl₂.4H₂O, were weighed and transferred to the reaction flask. The salts were then dissolved and the pH adjusted to 9.5 with 50% concentrated NH₄OH at 400 rpm under Argon for 30 minutes. The solution turned black indicating the formation of magnetite. The CH₂Cl₂ was then added and the stir rate increased to 500 rpm for two hours under a heavy flow of argon. The pH was then adjusted to 6.5 with 20% HCl and solution stirred for 30 minutes. The reaction mixture was then placed in a separatory funnel with 120 ml of CH₂Cl₂ to extract the particles and aqueous and organic layers allowed to separate. The CH₂Cl₂ was then filtered and removed under vacuum to yield a viscous, black liquid. Yield: 5.4 g Elemental analysis showed the particles contained 12.9 weight percent iron. Analysis of TEM data on another batch, prepared as above, showed the particle diameter of the magnetite particle core to average 10.99 nm (see FIG. 12). The coated magnetite particles formed a colloidal suspension in CH₂Cl₂.

### EXAMPLE 3

### Synthesis of Polyacid Backbone Coating for Magnetite Particles using Poly(Methacrylic Acid)

In a 500 ml round bottomed flask was placed sodium poly(methacrylate) (50 g) with 300 ml of acetic anhydride. This solution was refluxed overnight, then filtered and washed with boiling ethyl acetate, and placed under high vacuum to remove excess solvent. The resulting anhydride was then reacted with the carbamate derivative of poly(propylene glycol) monobutyl ether (30 g) to yield the polyacid backbone with attached PPG chains, as shown in FIG. 9.

### EXAMPLE 4

### Synthesis of Magnetite Particles Coated with the Polyacid Backbone Coating Prepared Using the Poly(Methacrylic Acid) Method (Alternate to Example 2)

In three separate flasks was placed 150 ml of deionized H₂O, 100 ml of CH₂Cl₂ containing 10 g of the poly(methacrylic acid) polymer coating prepared as in Example 3, and 75 ml of 50% concentrated NH₄OH. These were degassed for 30 minutes with argon. The salts, 10 g of FeCl₃.6H₂O and 3.68 g of FeCl₂.4H₂O, were weighed and transferred to the reaction flask. The deionized H₂O was added to the reaction flask and the salts were dissolved under argon. The pH was then adjusted to 9.5 with =30 ml of 50% concentrated NH₄OH at a stir rate of 400 rpm and this solution was stirred for 30 minutes under argon. The solution turned black indicating the formation of magnetite. The CH₂Cl₂ containing the polymer was then added and stirred at 500 rpm for 3 hours under a heavy flow of argon. The pH was then adjusted to 6.5 with 20% HCl and stirred for 30 minutes. Then solution was then poured into a 500 ml round bottom flask and material was collected magnetically. The material was then washed 3 times with 100 ml and the excess water was poured off and then lyophilized. The coated magnetite particles formed a stable suspension in CH₂Cl₂. Yield: 12.8 g

### EXAMPLE 5

### Water Dispersable Coated Particles

In 3 separate flasks were placed deionized water (40 mL), a solution of the coating material (4.0 g) in CH₂Cl₂ (25 mL), and 50% concentrated NH₄OH (25 μL). The coating material is prepared as in Example 1, but with poly(ethylene glycol) replacing poly(propylene glycol). The liquids were degassed for 30 min. with a stream of argon. Into an additional flask were weighed iron (II) chloride tetrahydrate (0.736 g) and iron (III) chloride hexahydrate (2.0 g). The flask was flushed with argon for five minutes, and then the iron salts were dissolved in the degassed deionized water. The iron chloride solution was transferred to the reaction vessel via syringe. The iron solution was stirred at 400 rpm under argon, the pH was adjusted to ≈9.5, and stirring was continued for an additional 30 minutes. The degassed solution of coating material in CH₂Cl₂ was added and the resulting mixture was stirred at 500 rpm with the argon flowed ceased. After 30 min. argon was rapidly flowed through the system for an additional 2 hrs. The pH of the reaction solution is adjusted to =6, then the mixture was stirred for 30 min. The mixture was extracted with CH₂Cl₂ (125 mL). Evaporation of the solvent in vacuo gave the coated magnetite as a thick black oil.

### EXAMPLE 6

### Preparation of Thiol-Terminated Poly(Propylene Glycol) Coating for Gold Particles

Procedure: The poly(propylene glycol) monobutyl ether Mn 2500 carbamate (1.75×10⁻² moles; 43.9 g) prepared as described in Example 1, Steps 1-3, substituting the 2500 Mn poly(propylene glycol) monobutyl ether for the 4000 Mₙ polymer, was dissolved in 100 mL distilled CH₂CL₂ along with dicyclohexyl carbodiimide (DCC, 2.24 g) and 4-dimethylaminopyridine (DMAP, 0.500 g) and stirred for 5 minutes. Mercapto acetic acid (1.75×10⁻² moles; 1.62 g; 1.2 ml) was added and the reaction was stirred at room temperature overnight. Workup: The solvent was removed in vacuo, resulting in a sticky, colorless oil. Hexanes (400 mL) were added and the reaction mixture was filtered to remove residual DCC. The filtrate was further diluted with hexanes (300 mL) and washed with 100 mL 10% HCl. The filtrate was dried over anhydrous MgSO₄ and removed, resulting in a viscous, light yellow oil (36.7 g; 81.2% yield).

### EXAMPLE 7

### Preparation of Thiol-Terminated Polymer Coated Gold Particles

Procedure: Hydrogen tetrachloroaurate (III) hydrate (HAuCl₄ xH₂O) (5.17×10⁻³ moles; 2.032 g) and tetrabutylammonium bromide (7.88×10⁻³ moles; 2.47 g) were added to 30 mL of Millipore water and stirred for five minutes. CH₂CL₂ (100 mL) was added resulting in a deep red, biphasic solution, which was stirred an additional 20 minutes. The red organic layer was separated from the colorless water layer, and the thiol-terminated poly(propylene glycol) coating (4.99×10⁻⁴ moles; 1.30 g), prepared as in Example 6, was added. The solution was stirred for an additional 30 minutes before the addition of NaBH₄ (7.9×10⁻² moles; 3 g in 10 mL H₂O). The resulting solution was left to slowly stir for one hour. The solution was poured into a separatory funnel and washed with 20% acetic acid solution followed by two washes with 200 mL H₂O until pH tested 7 with pH paper. The purple solution was dried with anhydrous MgSO₄ and filtered. The solvent was removed via rotoevaporation to yield a purple, waxy solid. The sample was placed in a vacuum oven at 55 degrees C. overnight. Elemental analysis showed the particles contained 41.0 weight percent gold. Analysis of TEM data on another batch, made as above, showed the average particle diameter of the gold particle core to be 10.3±3.2 nm (see FIG. 13). The coated gold particles formed a colloidal suspension in CH₂Cl₂.

Embolic Material

Embolic formulations are prepared using the coated magnetically responsive particles and other components that provide radiopacity and polymerization capability. The polymerization mechanism used in the embolic material is a radical chain polymerization of acrylate monomers using a peroxide as the initiator and achieving activation by a tertiary amine. This method for polymerization has been well studied (see D. S. Achilias, I. Sideridou, “Study of the Effect of Two BPO/Amine Initiation Systems on the Free-Radical Polymerization of MMA Used in Dental Resins and Bone Cements”, Journal of Macromolecular Science, 2002, Vol. A39, No. 12, 1435-1450). It is critical that all components are miscible, i.e. have similar HLB values, so that the embolic retains high internal cohesion during filling, to prevent migration of material downstream during aneurysm filling which may lead to the damage of healthy tissue.

In one preferred embodiment, the embolic formulation consists of coated magnetite particles suspended in a solvent monomer containing a bulking agent, a cross-linker, a radiopaque monomer, and an accelerant, which prior to use is mixed with a second solution comprising a monomer and an initiator (e.g. a peroxide).

In another preferred embodiment, the embolic formulation consists of coated magnetite particles suspended in a solvent monomer containing a bulking agent, a cross-linker, a coated radiopaque particle, and an accelerant, which prior to use is mixed with a second solution comprising a monomer and an initiator (e.g. a peroxide).

The embolic material is injected through a microcatheter to the site of the aneurysm, held in place magnetically, and then allowed to solidify via polymerization.

In either embodiment, it is necessary to have sufficient volume percent of the acrylates for consistent polymerization. The volume percent should preferably be greater than 30%. The embolic material is preferably provided in two parts, which are mixed just prior to use. Part I preferably comprises: coated magnetically responsive particles, a monomer (e.g. methyl methacrylate), a radiopaque monomer (e.g. 1-(2,3,5 triiodobenzoyloxy)-2-(methacroyloxy)ethane), a three-dimensional cross-linker (e.g., trimethylolpropane ethoxylate (14/3 EO/OH)), a bulking agent (thickener), (e.g., poly(methylmethacrylate)); and an accelerant (e.g., N,N-dimethyl toluidine (DMT)). Part II preferably comprises a monomer (e.g., methyl methacrylate), and an initiator (e.g., lauroyl peroxide (LPO)).

Part I preferably comprises 1 g methyl methacrylate monomer; 0.5 g 1-(2,3,5 triiodobenzoyloxy)-2-(methacroyloxy)ethane radiopaque monomer; 0.2 g Trimethylolpropane ethoxylate (14/3 EO/OH)), 1 g poly(methylmethacrylate) bulking agent; 0.02 g N,N dimethyl toluidine (DMT) accelerant; and 1.4 grams of the coated magnetic particles prepared in one of the previous examples. Part II preferably comprises a 3.31 g methyl methacrylate monomer; and 0.52 g lauroyl peroxide (LPO) initiator. 1 ml of Part 1 and 0.2 ml of Part II are mixed and ready for injection.

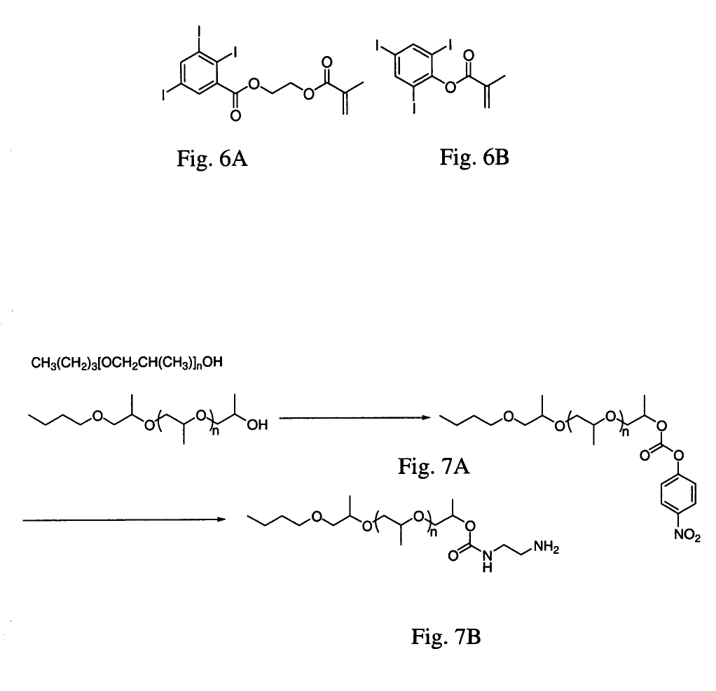

The 1-(2,3,5 triiodobenzoyloxy)-2-(methacroyloxy)ethane radiopaque monomer may be prepared using published procedures, for example those in A. Benzina, M.-A. B. Kruft, F. H. van der Veen, F. h. M. W. Bar, R. Bleezer, T. Lindhout, L. H. Koole, “Versatile Three-Iodine Molecular Building Block Leading to New Radiopaque Polymeric Biomaterials”, Journal of Biomedical Materials Research, 1996, 32, 459-466; “Synthesis and Polymerization of Some Iodine-containing Monomers for Biomedical Applications”, A. Jayakrishnan, B. C. Thando, Journal of Applied Polymer Science, 1992, 44, 743-748, (incorporated herein by reference). Two radiopaque monomers that can be used in embolic materials are shown in FIGS. 6A and 6B.

Preparation of Embolic Material

### EXAMPLE 8

### Preparation of Embolic Material with Radiopaque Monomer

In a 20 ml vial, add 0.796 g 1-(2,3,5 triiodobenzoyloxy)-2-(methacroyloxy)ethane), 2.0 g methyl methacrylate (99.5% pure monomer; Aldrich Chemical Company, St. Louis, Mo.) 0.516 g trimethylolpropane ethoxylate (14/3) EO/OH); triacrylate (Sartomer Company, West Chester, Pa., USA), and 0.014 g N,N-dimethyl toluidine (Aldrich Chemical Company, St. Louis, Mo.). Vortex for 20 minutes. Add 0.205 g poly (methyl methacrylate) (M_{W}≈20,000; Aldrich Chemical Company, St. Louis, Mo.) and vortex for 30 minutes to obtain a homogeneous, viscous solution. Add 2.597 g coated magnetite particles as prepared in Example 2. Vortex for one hour. In a second 7 ml vial, add 0.5 g of lauroyl peroxide (Luperox®, Aldrich Chemical Company, St. Louis, Mo.) and 1.976 ml of methyl methacrylate. Vortex at room temperature until the peroxide is dissolved. To prepare the embolic, add 0.1 ml of the peroxide solution to 1.0 ml of the viscous fluid containing the coated magnetite particles and vortex at room temperature for two minutes.

### EXAMPLE 9

### Flow Phantom Fills of Embolic Material with Radiopaque Monomer in Glass Lateral Aneurysm Model

Embolic material was prepared as described in Example 8. A glass lateral aneurysm model, with internal parent vessel diameter of 4.8 mm and an aneurysm with maximum diameter of 7.15 mm, was connected to a pulsatile flow system that circulated pig plasma at flow rates from 101 mL/min to 143 mL/min. The pig plasma was heated to 37° C. The aneurysm model was placed on the benchtop, 9.5 cm above the face of a square magnet in the first fill (“with gravity” i.e., with the force of gravity in the same direction as the force of the magnetic gradient) and 9.5 cm below the face of a square magnet in the second fill (“against gravity” i.e., with the force of gravity opposite to the direction of the force of the magnetic gradient). The magnetic field and gradient at this distance were 0.078 T and 1.06 T/m. The embolic material was injected through a microcatheter (Slip-Cath®; Cook Inc., Bloomington, Ind.). The aneurysm volume filled completely with embolic material, with no downstream migration of material. The filled aneurysm is shown in FIG. 11A (with gravity) and in FIG. 11B (against gravity).

What is claimed is:

1. An embolic material comprising a flowable, settable material, and a plurality of coated magnetically responsive particles disposed therein, the particles comprising cores of a magnetically responsive material between about 2 nm and about 20 nm in diameter, and a non-magnetically responsive layer around the core sufficient thickly to give the particles a diameter of between about 20 nm and about 40 nm.

2. The embolic material according to claim 1 wherein the cores of the particles have a diameter between about 7 nm and about 15 nm

3. The embolic material according to claim 2 wherein the layer is sufficiently thick to give the particles a diameter between about 25 nm and about 35 nm.

4. The embolic material according to claim 1 wherein the layer is sufficiently thick to give the particles a diameter between about 25 nm and about 35 nm.

5. The embolic material according to claim 1 wherein the magnetically responsive cores comprise iron or an iron compound.

6. The embolic material according to claim 5 wherein the magnetically responsive cores comprise magnetite (Fe₃O₄).

7. The embolic material according to claim 5 wherein the magnetically responsive cores comprise hematite (Fe₂O₃).

8. The embolic material according to claim 1 wherein the magnetically responsive cores include a radiopaque material.

9. The embolic material according to claim 1 wherein the non-magnetically responsive layer comprises a polymer backbone wherein each repeat unit of the polymer backbone is bonded to a long chain polymer and an anchor group, creating a plurality of long chain polymers and anchor groups on the polymer backbone.

10. The embolic material according to claim 9 wherein the polymer chains comprise poly(propylene glycol).

11. The embolic material according to claim 10 wherein the polymer chains include a carboxyl group anchoring the chains to the core.

12. The embolic material according to claim 9 wherein the polymer chains include a carboxyl group anchoring the chains to the core.

13. The embolic material according to claim 1 wherein the non-magnetically response layer comprises a polymer backbone with long chain polymers bonded to polymer repeat units and anchor groups bonded to different repeat units, creating a plurality of long chain polymers and anchor groups on the polymer backbone.

14. The embolic material according to claim 13 wherein the polymer chains comprise poly(propylene glycol).

15. The embolic material according to claim 13 wherein the backbones comprise carboxyl groups anchoring the backbones to the cores.

16. The embolic material according to claim 13 further comprising radiopaque moieties on the backbones.

17. The embolic material according to claim 1 wherein magnetically responsive material comprises less than or equal to about 5% by volume of the embolic material.

18. The embolic material according to claim 1 further comprising radiopaque particles.

19. The embolic material according to claim 18 wherein the radiopaque particles comprise gold cores of between about 7 and about 15 nm in diameter.

20. The embolic material according to claim 19 wherein the radiopaque particles comprise a non-magnetically responsive layer around the gold cores.

21. The embolic material according to claim 20 wherein the non-magnetically responsive layer comprises a plurality of polymer chains anchored to the cores.

22. The embolic material according to claim 21 wherein the polymer chains comprise poly(propylene glycol).

23. The embolic material according to claim 22 wherein the polymer chains include a thiol group anchoring the chains to the gold cores.

24. The embolic material according to claim 1 wherein the polymer chains are hydrophobic.

25. An embolic material comprising a polymerizable hydrophobic suspension of coated magnetically responsive particles (e.g. magnetite Fe₃O₄) suspended in a solvent monomer, a bulking agent, a radiopaque monomer, and an accelerant, and an initiator.

26. An embolic material comprising a mixture of (a) a polymerizable hydrophobic suspension of coated magnetically responsive particles (e.g. magnetite Fe₃O₄) suspended in a solvent monomer, a bulking agent, a radiopaque monomer, and an accelerant, and (b) a monomer and an initiator.

27. An embolic material comprising coated magnetically responsive particles, a monomer, a radiopaque monomer, a three-dimensional cross-linker; an accelerant; and an initiator.

28. An embolic material comprising coated magnetically responsive particles, a methyl methacrylate monomer, 1-(2,3,5 triiodobenzoyloxy)-2-(methacroyloxy)ethane) radiopaque monomer, Trimethylolpropane ethoxylate (14/3 EO/OH) three dimensional cross-linker, poly(methylmethacrylate) bulking agent; N,N dimethyl toluidine (DMT) accelerant; and lauryl peroxide (LPO) initiator.

29. An embolic material formed from mixing two parts, part I comprising coated magnetically responsive particles, a monomer, a radiopaque monomer, a three-dimensional cross-linker, a bulking agent, and an accelerant; and part II comprising a monomer and an initiator.

30. An embolic material formed from mixing two parts, part I comprising coated magnetically responsive particles, methyl methacrylate monomer, 1-(2,3,5 triiodobenzoyloxy)-2-(methacroyloxy)ethane radiopaque monomer, Trimethylolpropane ethoxylate (14/3 EO/OH) three dimensional cross linker, poly(methylmethacrylate) bulking agent; and N,N dimethyl toluidine (DMT) accelerant, and part II comprising methyl methacrylate monomer and lauryl peroxide (LPO) initiator.

31. The embolic according to claim 30, wherein part I comprises 1 g methyl methacrylate monomer; 0.5 g 1-(2,3,5 triiodobenzoyloxy)-2-(methacroyloxy)ethane radiopaque monomer; 0.2 g Trimethylolpropane ethoxylate (14/3 EO/OH)), 1 g poly(methylmethacrylate) bulking agent; 0.02 g N,N dimethyl toluidine (DMT) accelerant); and 1.4 grams of the coated magnetic particles; and Part II preferably comprises a 3.31 g methyl methacrylate monomer; and 0.52 g lauryl peroxide (LPO) initiator.

32. The embolic according to claim 31 wherein part I and part II are mixed in a volume ratio of about 5:1.

33. The embolic according to claim 30 wherein the coated magnetically responsive particles have an average diameter of between about 25 and about 35 nm.

34. The embolic according to claim 33 wherein the coated magnetically responsive particles have a magnetically responsive core with an average diameter of between about 5 and about 15 nm.

35. The embolic according to claim 34 wherein the coated magnetically responsive particles have an average diameter of about 30 nm, and magnetically responsive cores having an average diameter of about 10 nm.

36. A magnetically responsive embolic containing coated magnetic particles for which the magnetic core average diameter is between 5 and 15 nm and the coating thickness buffers the magnetic interactions so that the presence of an externally applied magnetic field will not cause a substantial departure of the embolic from a uniform mixture of its constituents.

37. The embolic of claim 36 in which the embolic is sufficiently self coherent that it will not separate in or at the surface of an aneurysm when the blood is flowing past at a velocity up to 80 cm/sec.

38. The embolic of claim 37 in which the magnetic core average diameter is between 5 and 30 nm diameter.

39. The embolic of claim 38 in which the embolic is sufficiently self coherent that it will not separate in or at the surface of an aneurysm when the blood is flowing past as a velocity up to 150 cm/sec.
